(19) United States
(12) Patent Application Publication
(10) Pub. No.: US 2009/0117339 A1
(43) Pub. Date: May 7, 2009

(54) METHOD OF COMPONENT ASSEMBLY ON A SUBSTRATE

(76) Inventors: Till Bocking, Boston, MA (US); John Justin Gooding, Chippendale (AU); Kristopher A. Kilian, Randwich (AU); Michael Gal, Engadine (AU); Katharina Gaus, Chippendale (AU)

Correspondence Address: JAGTIANI + GUTTAG, 10363-A DEMOCRACY LANE, FAIRFAX, VA, 22030, US

(21) Appl. No.: 11/933,541

(22) Filed: Nov. 1, 2007

(51) Int. Cl. B32B 3/00; B05D 5/06

(52) U.S. Cl. 428/195.1; 427/162

(57) ABSTRACT

A method of component assembly on a substrate, and an assembly of a bound component on a substrate. The method comprises the steps of forming a free-standing component having an optical characteristic; providing a pattern of a first binding species on the substrate or the free standing component; and forming a bound component on the substrate through a binding interaction via the first binding species; wherein the bound component exhibits substantially the same optical characteristic compared to the free-standing component.

### FIELD OF INVENTION

The present invention relates broadly to a method of component assembly on a substrate, and to an assembly of a bound component on a substrate.

### BACKGROUND

The creation of integrated optical devices from separate micro-components has, in the past, required time-consuming and often manually intensive methods. Attempts to alleviate these difficulties have seen the emergence of more mechanized technologies that focus on assembly either via fluidic self-assembly or methods that are based on wafer-to-wafer transfer. Key to all these technologies is the substrate which is either a specifically prepared ‘receptor’ with precisely etched holes that are complementary to the optical components, or substrates that require equally stringent photolithographic alignment and/or masking. The current technologies used for the integration of optical components are restricted by the limited number of compatible substrates (e.g. silicon, silicon oxide, gallium arsenide).

Ideally, the optical designer should not be limited by the fabrication technology. For example, one should be able to integrate III-V light sources and detectors with Si based photonic crystals, modulators and/or micro-mirrors, with SiO₂ waveguides, and non-linear optical devices on any substrate. The function and/or complexity of an integrated optical circuit should not be restricted by the substrate.

“Strained layer epitaxy” is used to integrate semiconductors with dissimilar lattice structures, such as growing GaAs on Si, or SiGe alloys on Si, etc. However, this technique is only possible if the respective layer thicknesses are thinner than a critical thickness which is typically extremely thin. In addition, this technique is only useful for crystalline materials, and is not useful for integrating non-crystalline materials such as plastics and glasses. The use of MEMS (Micro-Electro-Mechanical Systems) for integrating mechanical components, sensors, etc with electronics on a silicon substrate using microelectronic technology is also made use of. This technology relies on devices, such as micro-mirrors, waveguides, cantilevers, etc that are Si (and SiO₂) based and are micromachined into Si. Again, this method is limited to Si and SiO₂ and is not useful to integrate other materials, such as GaAs, electro-optic materials, etc

There are a number of other techniques that are grouped into ‘top-down’ and ‘bottom-up’ approaches. The top-down approach involves a block of material being processed into the desired shape and working unit. In bottom-up fabrication, small building blocks (usually nanoscale as the term originates from nanotechnology) are connected together to fabricate a functioning unit.

Current top-down approaches for integrating optical structures on a substrate typically involve fluidic assembly into defined ‘holes’ in a substrate, lithographic patterning followed by etching or wafer-to-wafer transfer. These are very complicated procedures that lack the ability to be easily scaled up and typically suffer from low fabrication success rates.

On the other hand, while there are many potential bottom-up strategies for fabricating optical structures on different materials, no current method for assembling high quality optical devices (prefabricated) on any substrate has been demonstrated. A sufficient understanding of how to assemble molecular building blocks with sufficient control to produce high quality materials (that is, comparable to microelectronics state of the art) has not been reached.

Recently, methods for electric field assisted self-assembly of functionalized DNA strands as building blocks for assembly and fabrication of devices have been proposed in U.S. Pat. No. 6,652,808. However, the methods disclosed in that document focus primarily on the control and chemical nature of the DNA based building blocks for bonding of components to a substrate, rather than providing any teaching with respect to the properties or functionality of the devices bound to the substrate. Furthermore, an approach for building a photonic band-gap structure is disclosed, where a photonic band-gap structure is built-up from metal beads exhibiting magnetic properties. The photonic band-gap structure is formed on the substrate through a process in which the metal beads are interconnected via DNA bonds. No optical characterization of such grown photonic band-gap structures is provided in that document.

Furthermore, there is no teaching provided in that document that verifies whether the alignment accuracy between the metal beads is actually sufficient to achieve a photonic crystal effect, and on which substrate or type of substrates. A technique for alignment of “larger” structures of the order of 10 to 100 microns is also discussed in that document, using selective derivatisation with different DNA sequences of a device to be positioned and oriented on a substrate. However, no teaching is provided with respect to handling of larger devices, thus limiting the proposed method to techniques in which the devices to be attached are smaller than about 100 microns, and with a need to apply individual devices in that size range to the substrate for assembly. The preparation of free-standing devices in that range of small sizes can constitute a major challenge in the overall assembly process, in particular with a view to mass-production of assemblies of devices on various substrates.

A need therefore exists to provide a method of component assembly on a substrate that seeks to address at least one of the above-mentioned problems.

### SUMMARY

In accordance with a first aspect of the present invention there is provided a method of component assembly on a substrate, the method comprising the steps of forming a free-standing component having an optical characteristic; providing a pattern of a first binding species on the substrate or the free standing component; and forming a bound component on the substrate through a binding interaction via the first binding species; wherein the bound component exhibits substantially the same optical characteristic compared to the free-standing component.

The forming of the bound component may comprise applying the free-standing component to the substrate for establishing the binding interaction via the first binding species, and removing portions of the free-standing component unbound via the first binding species such that the pattern of the first binding species is transferred to the formed bound component.

The method may further comprise providing a second binding species on the free-standing component or the substrate, and the binding interaction between the free-standing component and substrate is via the first binding species binding with the second binding species.

The substrate may comprise a further component formed thereon, and the at least a portion of the free-standing component is bound to a surface of the further component, and wherein the further component and the bound component from at least part of an integrated component.

The integrated component may comprise an optical component.

The method may further comprise forming a material layer on the further component, the free-standing component, or both, such that the material layer is sandwiched between the further component and the bound component in the integrated component.

The material layer may be chosen such that the integrated component exhibits a desired optical characteristic.

The material layer may comprise at least the first binding species.

The material layer may comprise an organic material, and the further component and the bound component may comprise inorganic materials.

The substrate and the free-standing component may be lattice mismatched.

The substrate may be flexible.

A lateral dimension of the bound component may be in the range of nm to mm.

The method may further comprise the step of providing a blocking species in areas not covered by the pattern of the first binding species, prior to forming the bound component on the substrate through the binding interaction via the first binding species, for enhancing the selectivity of the binding interaction.

The first binding species may be chosen such that the binding interaction comprises one or more of a group consisting of a biomolecular interaction, van der Waals forces, hydrogen bonding, hydrophobic/hydrophilic, metal coordination, electrostatics, and covalent bonding.

The method may comprise forming two or more different free-standing components, each free-standing component having an optical characteristic; providing respective patterns of two or more different first binding species on the substrate; and providing different second binding species on the respective different free-standing components corresponding to the respective different first binding species, forming respective bound components on the substrate through binding interactions between the different free-standing components and the different first binding species via the different corresponding second binding species; wherein the bound components exhibit substantially the same respective optical characteristics compared to the corresponding free-standing components.

In accordance with a second aspect of the present invention there is provided a assembly comprising a substrate; and a bound component assembled on the substrate through a binding interaction via a first binding species provided on the substrate or on a free-standing pre-form of the bound component; wherein the bound component exhibits substantially a same optical characteristic compared to the free-standing pre-form.

The bound component may be a portion of the free-standing pre-form with other portions of the free-standing pre-form unbound via the first binding species removed.

The assembly may further comprise a second binding species on the bound component or the substrate, and the binding interaction between the bound component and substrate is via the first binding species binding with the second binding species.

The substrate may comprise a further component formed thereon and the bound component is bound to a surface of the further component, and wherein the further component and the bound component from at least part of an integrated component.

The integrated component may comprise an optical component.

The assembly may further comprise a material layer on the further component, the bound component, or both, such that the material layer is sandwiched between the further component and the bound component in the integrated component.

The material layer may be chosen such that the integrated component exhibits a desired optical characteristic.

The material layer may comprise at least the first binding species.

The material layer may comprise an organic material, and the further component and the bound component comprise inorganic materials.

The substrate and the bound component may be lattice mismatched.

The substrate may be flexible.

A lateral dimension of the bound component may be in the range of nm to mm.

The assembly may comprise respective patterns of two or more different first binding species on the substrate; and different second binding species on respective different bound components corresponding to the respective different first binding species, the bound components being bound through binding interactions between the bound components and the different first binding species via the different corresponding second binding species; wherein the bound components exhibit substantially the same respective optical characteristics compared to respective corresponding free-standing pre-forms of the different bound components.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic representation of assembly of optical components according to an example embodiment.

FIGS. 2a to d show the characteristic optical reflectivity spectra of a PSi microcavity as prepared, and assembled on GaAs, silicon dioxide and poly carbonate respectively, using the method of FIG. 1.

FIG. 3a shows reflectivity spectra of two different microcavities assembled on the same polycarbonate substrate using the method of FIG. 3b.

FIG. 3b shows a schematic representation of attachment of two different microcavities onto different locations of the same substrate according to an example embodiment.

FIG. 4 shows a schematic representation of the assembly of microcavities from parts according to an example embodiment.

FIGS. 5a and b show reflectivity spectra of structures fabricated using the method of FIG. 4 before and after assembly of mirrors.

FIGS. 6a to c show reflectivity spectra of a Bragg mirror and different assembled microcavity structures fabricated using the method of FIG. 4.

FIG. 7 shows a scanning electron microscopy (SEM) image of a structure fabricated using the method of FIG. 4.

FIG. 8 shows a profilometry trace of the structure of FIG. 7.

FIG. 9 shows details of the success rate of assembling a final microcavity using the method of FIG. 4.

FIG. 10 is a schematic representation showing assembly of microcavities on a substrate using a sandwich approach according to another embodiment.

FIGS. 11a to d show the optical properties of a substrate reflector and formed microcavities with different spacer layers respectively fabricated using the method of FIG. 10.

FIG. 12a shows reflectivity spectra of a PSi Bragg mirror before and after deposition of a PMMA layer by spin coating, according to another example embodiment.

FIG. 12b shows reflectivity spectra of microcavities fabricated using a PMMA spacer layer in the method of FIG. 10.

FIG. 13 shows a flow chart illustrating a method of component assembly on a substrate according to an example embodiment.

### DETAILED DESCRIPTION

The integration of different optical components on the same substrate, as well as optical components with electronic devices, has been hindered by different components typically being made of different materials. Hence a problem has existed where either optical components are all made from the same material, hence compromising the performance of some or all of the components, or the problem has been how to integrate components made from the different materials onto the same substrate. Thus the problem is one of material incompatibility. The described example embodiments provide methods that can overcome this problem by harnessing the recognition properties of biological molecules to enable the assembly of optical materials on any substrate. Porous silicon (PSi) microcavities and Bragg mirrors are fabricated and assembled on silicon, gallium arsenide and plastic. The substrate material is modified by application of a biological molecule to define the location for assembly. Optical components modified with the complementary biomolecule self-assemble only onto the correct location without compromising their optical integrity. In another embodiment optical components can be deposited onto and adhered to a substrate via patterns of an adhesive ultrathin coating. Furthermore, the technique in the example embodiments allows assembly of new devices from components of different composition as demonstrated by incorporating different spacer layers between porous silicon Bragg mirrors to create a resonant microcavity.

Described embodiments use biomolecule directed or adhesive coating directed assembly of prefabricated high quality optical structures on the micro and macroscale without micromachining requirements. In contrast to biomolecule directed assembly of photonic crystals from colloidal building blocks (described e.g. in U.S. Pat. No. 6,752,868 B2), which cannot produce the high quality optical structures required for the fabrication of optical circuits, in example embodiments high quality Bragg mirrors and resonant microcavities were formed by anodization of silicon. In one embodiment, the macroscale assembly of optical films occurs on substrates patterned with complementary biological molecules. The high affinity of biorecognition causes assembly at the applied pattern only, while the remainder of the film fractures upon rinsing and drying steps leaving a macroscale pattern of optical structures (>1 mm). In another embodiment, a macroscopic free-standing optical structure was fractured by sonication in ethanol to produce microparticles (<100 μm). Utilizing biorecognition, the optical microparticles are assembled in the correct orientation when applied to the biomolecule labelled substrate. Example embodiments of the present invention can create optically flat materials on a macroscale such that high quality optical characteristics are maintained. In contrast to building an optical structure using the bottom up approach, example embodiments can allow assembly of prefabricated high quality optical components over multiple length scales.

Example embodiments assemble optical materials on any substrate that allows biorecognition or deposition of thin coatings to mate the materials together. In one embodiment, resonant microcavities fabricated with porous silicon were removed from silicon and coated with biorecognition molecules. A number of substrates including: silicon, silicon dioxide, galium arsenide and polycarbonate, were patterned with aqueous solutions of complementary biomolecules. Application of the labelled microcavities to the patterned substrates yielded assembly at the biomolecular pattern only, while the remaining microcavity was rinsed away with ethanol.

Example embodiments provide a combination of high quality top-down optical structure fabrication techniques with a bottom-up assembly method (a hybrid approach) exploiting biorecognition or an adhesive coating to form new devices. Previous work on assembling optical structures has involved either 1) the top-down fabrication of optical materials (e.g. PSi microcavity formation) or 2) bottom-up assembly of new optical materials (e.g. colloidal crystal fabrication). By first forming high quality optical materials using top-down fabrication followed by e.g. biomolecule directed assembly of multiple components, a high quality optical structure can be created in example embodiments. Other materials (e.g. responsive polymers and small molecules, metals, nanoparticles and objects, redox and photosynthetic proteins, molecular wires, carbon nanotubes, ionic liquids/liquid crystals, lipid layers, cells, diatoms, silica and polymer beads and many other functional molecules and materials) can be incorporated with the high quality optical structures such that novel properties and new emergent functions may be harnessed.

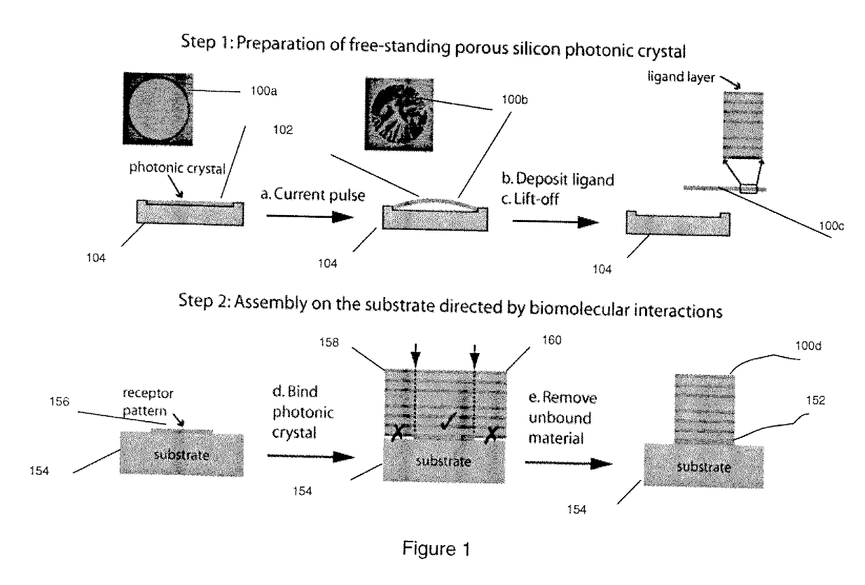

FIG. 1 shows a schematic representation of the assembly of optical components by specific adhesion onto any substrate via biomolecular interactions in an example embodiment. Porous Silicon (Psi) optical resonant microcavities (1D photonic crystals) are prepared as free-standing films 100c in a first sequence and then deposited via biorecognition-mediated self-assembly onto a substrate 154 in a second sequence. The photographs in FIG. 1 show top views of an as prepared PSi Bragg mirror 100a and the PSi Bragg mirror 100b after application of a current pulse. The PSi film 100b remains attached to the wafer 104 around the edge allowing modification with proteins on the top surface 102 while the bottom surface remains unmodified. It is noted that the components are not drawn to scale; the thickness of the free-standing PSi photonic crystal 100c is between 1.5-3 μm whereas the thickness of the combined ligand and receptor layer 152 is in the order of 10 nm. The assembly of microcavities with spacer layers of optical thickness corresponding to the half wavelength of visible light (n·d=λ/2) in the example embodiment demonstrates the capability to assemble delicate optical devices that can be tested and characterized. PSi has proven to be particularly well-suited for the production of high quality optical devices, such as one-dimensional photonic crystals including Bragg mirrors, optical filters and microcavities, as its refractive index can be precisely and continuously tuned between approximately 1.3 and 3.0. The PSi based microcavities are fabricated by electrochemical etching the single crystal Si wafer 104, whereby the etching-current density determines the porosity and hence the refractive index of the material.

For the PSi film 100a photonic crystal formation, the Si(100) wafer 104 (p++, B-doped, 0.005 Ωohm cm, single side polished) was cleaned by sonication in ethanol and acetone and blown dry under a stream of nitrogen. The cleaned wafer 104 was etched in an electrochemical cell with a polished stainless steel electrode as back-contact and a Pt ring counter electrode using 25% ethanolic HF (mixture of 50% aqueous HF and 100% ethanol, 1:1, v/v) as electrolyte. The power supply was controlled using custom written software to modulate the current density and etching times during the etching process. Etch stops were incorporated into the etching program to allow recovery of the HF concentration at the etching front. The current densities and etch times required to obtain the PSi layer 100a of desired porosity and thickness were calculated from calibration curves obtained for each batch of Si wafers and etching solutions.

At the end of the electrochemical etching that creates the cavity, a high current pulse is applied (FIG. 1, Step a) to ‘lift-off’ most of the microcavity from the underlying Si wafer 104. As a result, the approximately 3 μm thick PSi film 100b (microcavity), in this example, becomes free from the underlying substrate but remains attached at the edges. Maintaining the cavity attached to the Si wafer 104 is advantageous to enable simple further modifications for the self-assembly process. For details of a suitable technique to achieve “lift-off” reference is made to [H. Koyama, M. Araki, Y. Yamamoto, N. Koshida, Japanese Journal of Applied Physics 30, 3606 (1991)], the contents of which are hereby incorporated by cross reference. After lift-off, the sample was carefully rinsed with ethanol followed by pentane and dried under a very gentle stream of nitrogen with gentle heating. The modification employed in this example involves the physisorption of a particular biorecognition element (e.g. a ligand) onto the exposed surface 102 of the microcavity 100b (FIG. 1, Step b). Proteins (e.g. avidin or biotinylated albumin) were deposited onto the hydrophobic surface of as-prepared PSi film 100b by physisorption from aqueous solution. Aqueous solutions do not enter the pores of as-prepared PSi film 100b.

Subsequently, the modified device 100c is released from the Si wafer 104 (FIG. 1, Step c) and inverted onto a substrate 154 of choice which is pre-modified with a pattern of the complementary biomolecular species 156 (e.g. a receptor) (FIG. 1, Step d). The protein-modified lift-off sample 100b (still attached at its edge to the underlying Si wafer 104) was released from the Si wafer 104 by scoring the edge of the PSi film 100b with a sharp tip and floating the released PSi film 100c off the Si wafer 104 in this example embodiment. The assembly substrate 154 was spotted with solutions of protein to define the positions for adhesion. Subsequently, poly(ethylene glycol) was physisorbed elsewhere onto the substrate surface as a blocking species in this example embodiment to diminish binding of the protein-modified free-standing Psi film 100c to the bare substrate 154 surface. Portions 158, 160 of the PSi photonic crystal 100c not bound to the substrate 154 via the biorecognition pair 152 can simply be washed away to leave microcavities 100d only bound at positions determined by the receptor pattern 156 on the substrate 154 (FIG. 1, Step e). The substrate 154 was then vigorously rinsed to remove non-bound or weakly bound portions 158, 160 of the PSi film 100c elsewhere on the substrate 154. Removal of avidin-modified portions 158, 160 non-specifically adhering to the BSA-coated substrate 154 areas was performed using a detergent in the removal process in the example embodiment. Depending on the nature of the binding species in different embodiments, the use of a detergent is optional.

It is noted that other blocking species may be used in different embodiment, including, but not limited to, thin films of or self assembled monolayers (SAMs) terminated with

ethers and derivatives of poly-/oligo-(ethylene glycol)

amines/ammonium salts

amides, amino acids, peptides

Crown ethers

sugars, polyols (eg mannitol)

surfactants (eg Triton X-100)

zwitterionic groups (eg phosphrylcholine)

perfluorinated groups

protein

synthetic polymers

natural polymers or combinations thereof. It is noted that, depending on the nature of the binding species in different embodiments, the use of a blocking species is optional.

As seen in FIG. 1, the method in the example embodiment results in an assembly comprising the substrate 154 and the bound microcavities 100d assembled on the substrate 154 through a binding interaction via a binding species in the form of a biorecognition pair. In another embodiment described below, the binding species can be in the form of an adhesive layer provided on the substrate or the free-standing component.

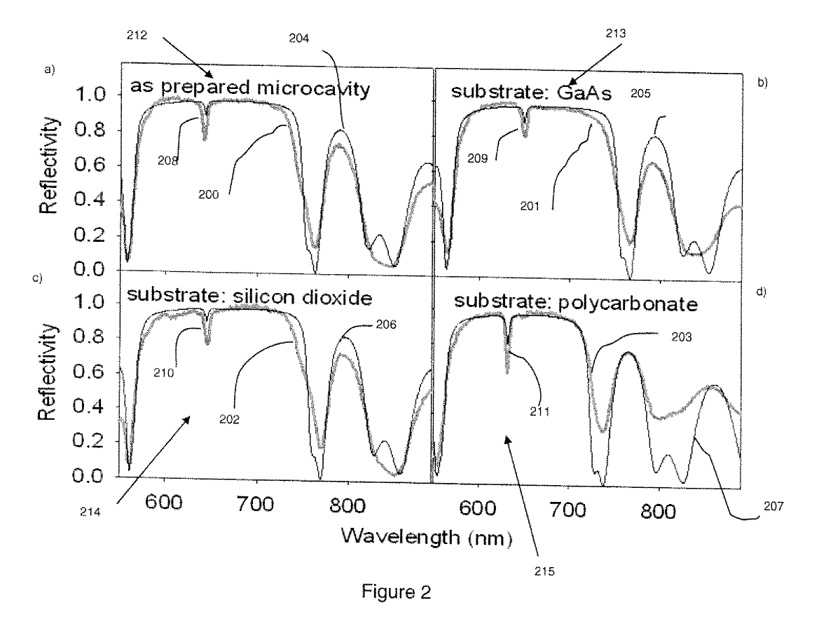

It is important to note that the optical properties of the devices advantageously remain the same independent of the substrate in different example embodiments. FIGS. 2a-d show the characteristic optical reflectivity spectra 200 to 203 of the same PSi microcavity (compare 100d in FIG. 1) as prepared (before lift-off), and assembled on GaAs, silicon dioxide and polycarbonate, respectively, as directed by the interaction between the protein avidin on the device and spots of the complementary biotinylated bovine serum albumin (BSA) on the substrate. Lines 204-207 represent simulations of the structures. The parameters used for the simulations are given in Table 1 below. The simulations are based on the effective medium formula by Looyenga (Physica 31, 401-406, 1965), which has been validated for p++-type PSi (Squire et al, J Lumin 80, 125-128, 1999):

n_{PSi}^{1/3}=(1−p)n_{Si}^{1/3}+pnₐᵢᵣ^{1/3}

The starting parameters of the simulation (layer thickness and porosity) were taken from the etching program which calculates current density and etch times for a desired layer thickness and porosity from calibration curves. The values were then refined to achieve good agreement between the measured spectrum and the simulation. For a number of samples the total thickness of the PSi sample was determined by profilometry to validate the layer thickness values used in the simulations. In FIG. 2a-d, L=low porosity (high refractive index) layer, H=high porosity (low refractive index) layer, S=spacer layer, d=layer thickness, n=refractive index. The structure of the microcavities is (LH)₇L-S-(LH)_{g}L.

TABLE 1

| | | |
|---|---|---|
| layer | d/nm | n |

as prepared

| | | |
|---|---|---|
| L | 62 | 2.24 |
| H | 91 | 1.60 |
| S | 186 | 1.60 |

GaAs

| | | |
|---|---|---|
| L | 62 | 2.25 |
| H | 91 | 1.62 |
| S | 187 | 1.62 |

silicon dioxide

| | | |
|---|---|---|
| L | 62 | 2.26 |
| H | 91 | 1.61 |
| S | 184 | 1.61 |

polycarbonate

| | | |
|---|---|---|
| L | 62 | 2.13 |
| H | 91 | 1.62 |
| S | 182 | 1.62 |

The reflection spectra 200-203 of the optical cavity are characterized by sharp ‘dips’ 208-211 in the reflectivity at the resonant frequency in the Bragg plateaus 212-215 (the regions of high reflectivity). The position and spectral width of the resonance is a sensitive measure of the structure and quality of the cavity. As can be seen in FIGS. 2a-d, the cavity resonance is at approximately the same frequency (wavelength) and has approximately the same width for all substrate types, indicating that the cavity is impervious to the substrate.

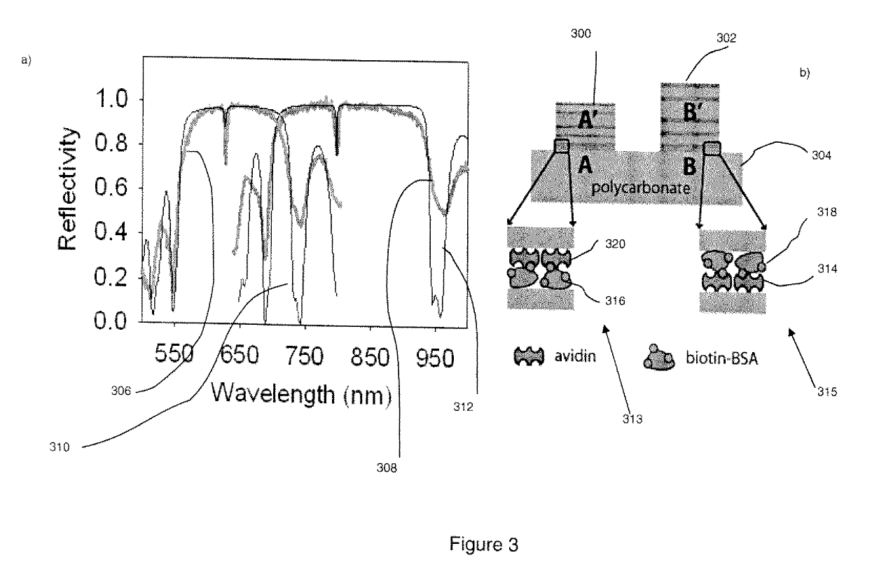

As a self-assembly approach, an advantage of the described embodiments is the possibility of depositing several components simultaneously without the need to individually align them at the desired locations on the substrate, as this task is performed by the biorecognition. Another benefit of using biorecognition to assemble optical structures in the example embodiments is the possibility to self-assemble different optical components onto the same substrate by using different biorecognition pairs. This concept is demonstrated in FIG. 3b showing the attachment of two different microcavities 300, 302 with distinct resonant frequencies, onto different locations of the same substrate 304 which, in this example embodiment, is a polycarbonate film. The measured reflectivity spectra 306, 308 of the two different microcavities 300, 302 assembled on the same polycarbonate substrate 304 as directed by biomolecular interactions are shown in FIG. 3a. Lines 310, 312 represent simulations of the structures. FIG. 3b also schematically shows the biorecognition pairs 313, 315 for the respective structures 300, 302 deposited at defined positions on the substrate 304.

In this example, at location B the substrate 304 is modified with avidin 314, whilst at location A the substrate 304 is modified with biotinylated BSA 316. The two separate free standing microcavities, B′ 300 and A′ 302, are modified with biotinylated BSA 318 and avidin 320, respectively. Biorecognition therefore dictates that cavity A′ 300 assembles at position A, and similarly, the avidin modified cavity B′ 302 binds to the biotinylated substrate 304 at location B. It was found that cavity B′ 302 did not assemble over spot A or vice versa. Also, there is no need to align each optical cavity 300, 302 precisely with its respective receptor spot(s) 314, 316 on the substrate 304. Unbound regions of the deposited free-standing structure simply break away during the washing step (compare FIG. 1, Step e).

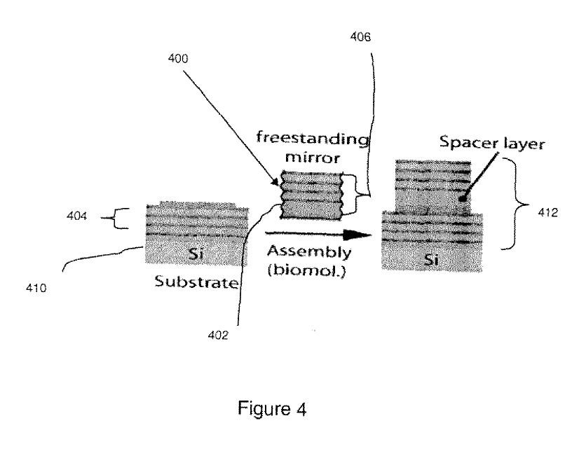

In other embodiments, biorecognition is also capable of self-assembling optical devices from separate components. In one example, PSi microcavities were assembled from two independent Bragg mirrors using biorecognition to create the desired resonant cavities. The steps used are shown in FIG. 4, which shows a schematic representation of the assembly of microcavities from parts in one example embodiment. A free-standing Bragg mirror 400 with spacer layer 402 is bound to a substrate Bragg mirror 404 via biomolecular interactions. The free standing PSi film 406 consisting of the Bragg mirror 400 and the spacer layer 402 is placed onto the PSi Bragg mirror 404 that was grown on a substrate 410. Biorecognition is used to mate the two parts to form the cavity 412. The assembly of microcavities was chosen to demonstrate the robustness and integrity of the biomolecular self-assembly approach as any non-uniformity in the produced spacer layer microcavity will result in poor optical characteristics.

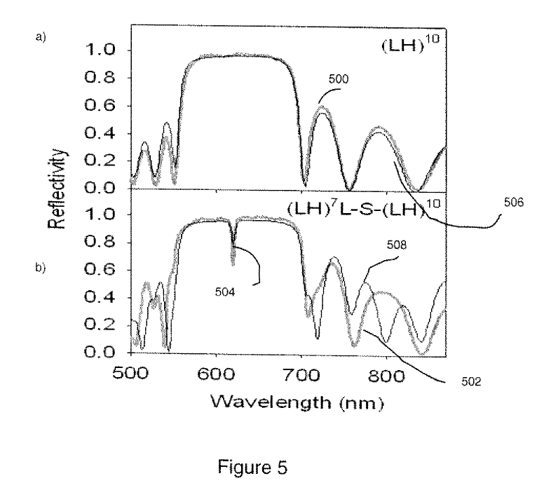

To test the formation of a cavity resonance, the reflectivity spectra 500, 502 of the structures were measured before and after assembly of the mirrors, shown in FIGS. 5a and b respectively. Prior to assembly of the free-standing mirror, the Bragg plateau of the substrate mirror spans a wavelength range of 550 to 700 nm. The successful assembly of the microcavity on the substrate is confirmed by the appearance of the pronounced cavity resonance 504 at 620 nm. As the cavity resonance is particularly sensitive to the parallelism of the two mirrors and the homogeneity of the spacer layer, it can be concluded that self-assembly based on biorecognition in this example embodiment is compatible with optical manufacturing of subtle devices. The deposited Bragg mirror consists of seven periods of alternating low and high porosity layers followed by a high porosity spacer layer. Lines 506, 508 represent simulations of the reflectivity. L=low porosity (high refractive index) layer, H=high porosity (low refractive index) layer, S=spacer layer. The parameters used for the simulations are given in Table 2.

TABLE 2

| | | |
|---|---|---|
| Layer | d (nm) | n |

Bragg mirror

| | | |
|---|---|---|
| L | 62 | 2.08 |
| H | 91 | 1.63 |

Microcavity

| | | |
|---|---|---|
| L | 62 | 2.08 |
| H | 91 | 1.60 |
| S | 184 | 1.60 |

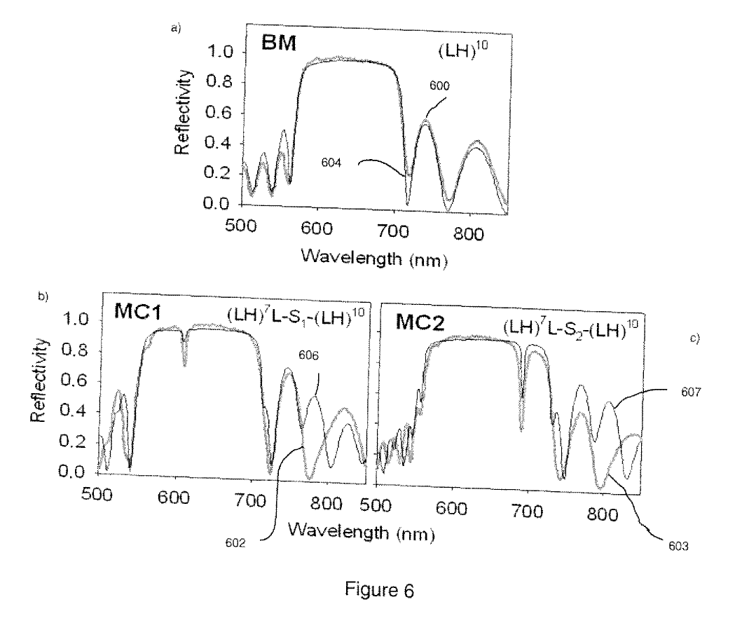

To further test this capability, several cavities with spacer layers of different optical thicknesses (which can be achieved either by varying the thickness or the porosity of the layer) were fabricated via deposition of a Bragg mirror with integral spacer layer, and the cavity resonance was always in agreement with theoretical predictions. FIGS. 6a to c show reflectivity spectra 600, 602, and 603 of a substrate Bragg mirror (BM) and different assembled microcavity structures respectively, assembled on the same substrate as directed by biomolecular interactions using the approach described above with reference to FIG. 4. Lines 604, 606, and 607 represent simulations of the structures. The parameters used for the simulations are given in Table 3. In FIG. 6, L=low porosity (high refractive index) layer, H=high porosity (low refractive index) layer, S spacer layer.

TABLE 3

| | | |
|---|---|---|
| layer | d/nm | n |

Bragg mirror (BM)

| | | |
|---|---|---|
| L | 62 | 2.15 |
| H | 89 | 1.63 |

microcavity (MC1)

| | | |
|---|---|---|
| L | 62 | 2.15 |
| H | 89 | 1.58 |
| S | 169 | 1.58 |

microcavity (MC2)

| | | |
|---|---|---|
| L | 62 | 2.20 |
| H | 89 | 1.57 |
| S | 256 | 1.57 |

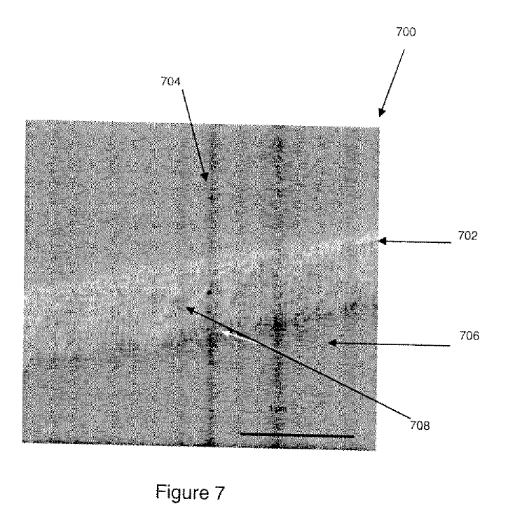

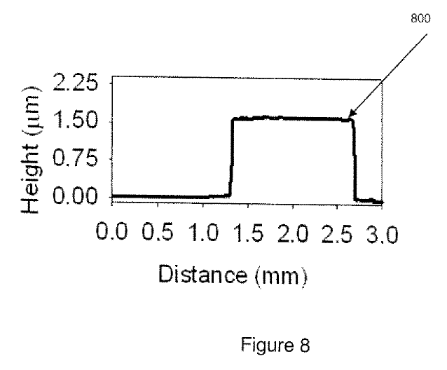

Further evidence for the uniformity of the assembly of optical structures is obtained from SEM and profilometry measurements. The SEM image 700 in FIG. 7 shows the edge 702 of a 1.5 μm thick PSi Bragg mirror film 704 bound to a substrate mirror 706 via biorecognition. The spacer layer of the microcavity (etched as an integral part of the free-standing mirror) is apparent as a distinct layer 708 adjacent to the substrate 706. The uniformity of the binding between the two components over a large length scale is also apparent in the profilometry trace 800 shown in FIG. 8. The adhesion resulting from the multiple biomolecular interactions between the two optical components was sufficiently robust that the structures remained intact even after prolonged sonication in water or ethanol.

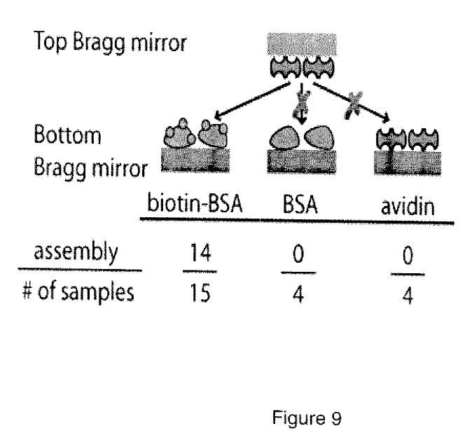

Apart from being able to assemble or form high quality optical structures, the usefulness of the biomolecular self-assembly technique in the example embodiments is determined by the success rate of forming the correct device in the correct location. FIG. 9 provides details of the success rate of assembling the final microcavity. When the substrate reflector was modified with biotinylated BSA, 14 out of 15 avidin-modified lift-off reflectors correctly assembled into the specific microcavity. Significantly, when the substrate reflector was modified with either BSA alone (i.e. no conjugated biotin) or avidin, then no microcavities were successfully assembled. Hence the specific biological binding reaction is the condition for device assembly in such embodiments.

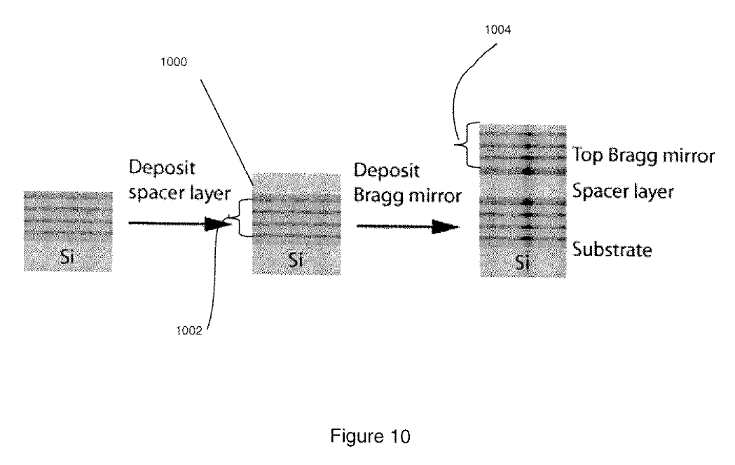

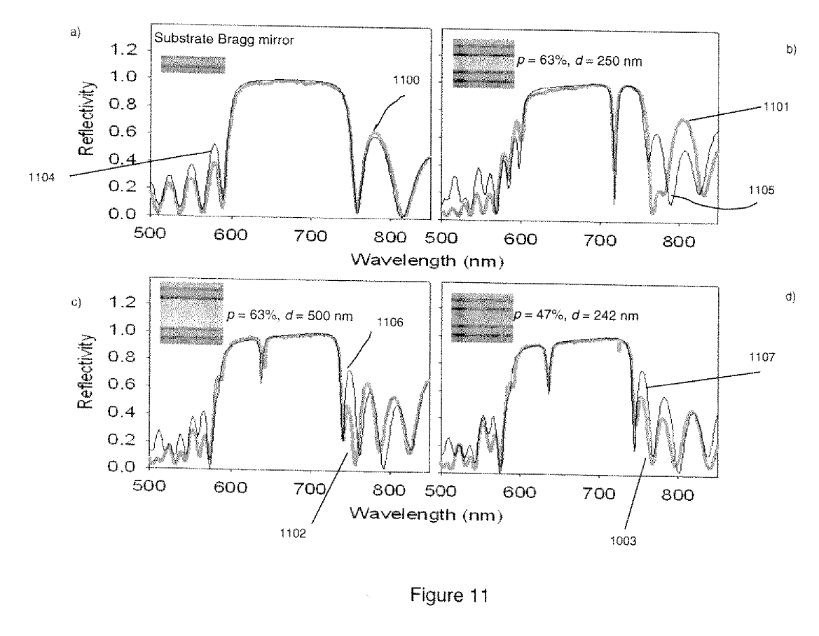

Using separate components to assemble optical structures has additional benefits. In the case of optical microcavities, the method of example embodiments can allow complete flexibility in choosing the mirrors and the spacer layer. FIG. 10 shows assembly of microcavities on Si using a sandwich approach: First a spacer layer 1000 is deposited onto a substrate Bragg mirror 1002, in this example embodiment using assembly of a free standing spacer layer 1000 via bio recognition or an adhesive coating, followed by assembling the top Bragg mirror 1004 on the spacer layer 1000 via bio recognition or an adhesive coating. For example, this technique would make it possible to build vertical cavity surface emitting lasers (VCSELs) using PSi mirrors and III-V spacer layers, or III-V mirrors and Er:glass spacer layer, or insert a sensitized spacer layer into a cavity. FIGS. 11a-d show the optical properties of the substrate reflector and the formed microcavities where different spacer layers, grown as separate PSi thin films with different porosities and thicknesses, were embedded into the cavity. Adhesion was achieved using proteins deposited onto the PSi spacer layer. FIG. 11a shows the spectrum 1100 of the underlying (substrate) Bragg mirror consisting of ten periods of alternating high and low refractive index layers. FIGS. 10b-d show the spectra 1101-1103 of sandwich structures with different porosity (refractive index) or thickness spacer layers as indicated. The free-standing Bragg mirror deposited onto the spacer layer to complete the microcavity structure consists of 8 periods of alternating low and high refractive index layers. Lines 1104-1107 show simulations of the optical structures. The parameters used for the simulations are given in Table 4.

TABLE 4

| | | |
|---|---|---|
| layer | d/nm | n |

a)

| | | | |
|---|---|---|---|
| 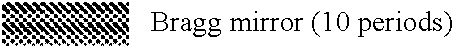 | L H | 68 92 | 2.15 1.62 |

b)

| | | | |
|---|---|---|---|
| 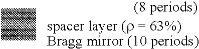 | L H S1 | 65 95 250 | 2.15 1.64 1.69 |

c)

| | | | |
|---|---|---|---|
| 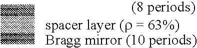 | L H S2 | 67 91 500 | 2.15 1.62 1.69 |

d)

| | | | |
|---|---|---|---|
| 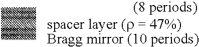 | L H S3 | 68 91 242 | 2.16 1.62 2.06 |

In a further embodiment, poly(methyl methacrylate) (PMMA), a common laser gain medium and lithographic material, was spin-coated onto a substrate mirror followed by assembling a free-standing mirror to define the microcavity. It was found that by spin-coating different thickness polymer layers, the frequency (wavelength) of the final cavity resonance can be easily tuned. This embodiment enables the integration of organic materials with (inorganic) high quality optical components.

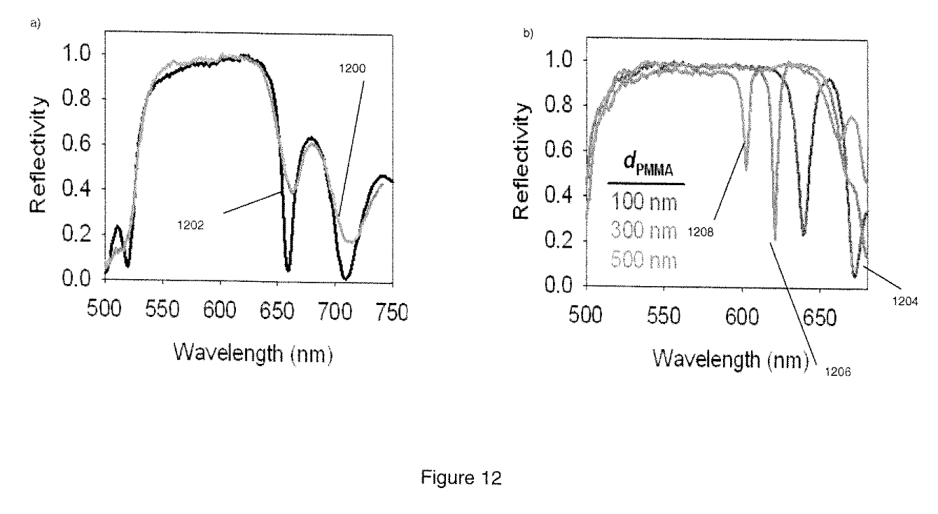

FIG. 12a shows reflectivity spectra 1200, 1202 of a PSi Bragg mirror before and after deposition of an approximately 500 nm thick layer of PMMA by spin coating respectively. The positions of the Bragg plateau and the interference fringes do not shift after deposition of PMMA, which demonstrates that the polymer did not enter the pores of the PSi structure, i.e. the properties of the cavity layer can be adjusted without altering the composition and optical properties of the Bragg mirror. FIG. 12 b shows reflectivity spectra 1204, 1206, and 1208 of microcavities fabricated by the approach described above with reference to FIG. 10 with a PMMA polymer spacer layer (deposited by spin coating) of thicknesses of 100 nm, 300 nm, and 500 nm respectively. The thickness was determined by the manufacturer spin coating PMMA protocol in the example embodiments.

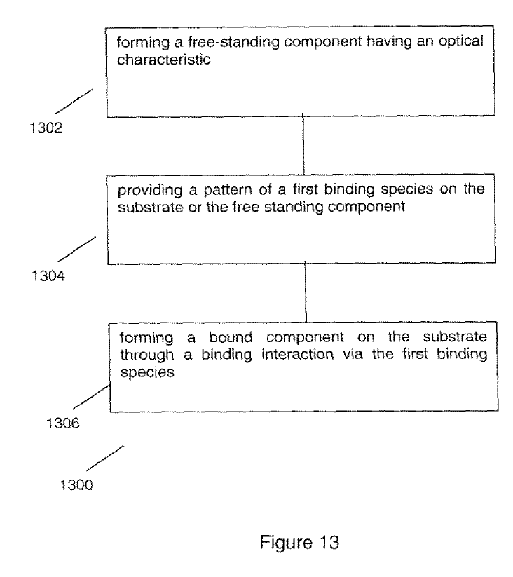

FIG. 13 shows a flow chart 1300 illustrating a method of component assembly on a substrate according to an example embodiment. At step 1302, a free-standing component having an optical characteristic is formed. At step 1304, a pattern of a first binding species is provided on the substrate or the free standing component. At step 1306, a bound component is formed on the substrate through a binding interaction via the first binding species, wherein the bound component exhibits substantially the same optical characteristic compared to the free-standing component.

The high degree of strength and uniformity imparted with biorecognition or with the use of adhesive coatings and the prospect of removing unbound material makes the approach in the example embodiments amenable to lithographic patterning. For instance, inkjet printing or soft lithographic stamping of proteins could define the circuit geography and deposition of silicon photonic material accomplished by the methods of the example embodiments. Furthermore, the approach can be extended for any optical material such that patterning different biomolecules for mixing different components could provide unprecedented ease and flexibility in optoelectronic circuit construction especially when taking into account the wide range of surface functionality that can be introduced on semiconductors (e.g. via hydrosilylation chemistry for Si and PSi), metals and polymers. Incorporating the cavity layer separately was demonstrated using thin PSi layers and PMMA in example embodiments. Different doping schemes can allow material to be confined exclusively to the cavity layer, a major advantage to using PSi for lasing applications. Incorporating alternative polymeric materials into the resultant photonic assembly is also possible and can open the door for new composite materials for diverse applications (e.g. laser gain medium, optical switches, biosensing at the cavity layer etc.).

The described embodiments provide methods that utilize biological recognition as a driving force for assembling photonic components into more complex architectures on a larger range of substrates. With the continued need to develop robust and flexible strategies to incorporate photonic components into complex devices, this advance expands current capabilities into composite materials. In conjunction with the evolving landscape of lithographic techniques and nanofabrication, harnessing the power of nature's complexity with self-assembling systems in the example embodiments can become a powerful synergistic tool for technological advancement in e.g. the photonic industries.

Current strategies for integrating optical components on a substrate require wafer-to-wafer transfer or photolithographic masking and etching to define a precise pattern that physically holds the optical components. In contrast, in the described embodiments, registration of optical components can be performed by spotting a biomolecule solution in a defined location. Importantly, the biomolecule pattern on the substrate dictates the patterning such that rinsing removes any non-specifically bound optical material. Thus the example embodiments allow a simple and flexible method to spatially array optical components which is amenable to existing liquid handling techniques, such as inkjet printing or soft lithographic stamping.

The described embodiments can provide a platform technology that allows, inter alia,
Integration of any optical material with any substrate thus eliminating issues of compatibility between the different materials that are better suited for each type of optical component.
Simple application of a biological species in a defined pattern dictating the geography for assembling the component thus providing a simple method of patterning and registration.

By integrating different components on any substrate and simplifying the registration of optical components on the substrate, the example embodiments can lead to new and novel materials and even multiple different materials to be incorporated into optical devices by using the described biological assembly approach. This described methods in example embodiments have the potential to revolutionize the way optical devices and integrated optical circuits are fabricated and thus can lead to improvements in current technologies and many novel devices.

The example embodiments can allow virtually unlimited resources for fabrication diversity. For instance, different combinations of the four bases of DNA or RNA for hybridization assembly, using DNA ligands that bind proteins, called aptamers, can be fabricated and screened using a process called SELEX, monoclonal/polyclonal antibody production for many different antigens, phage display library screening to optimize recognition, use of combinatorial peptide libraries for the selection of peptides binding to inorgranic substrates, protein:protein recognition. Thus the choice of assembly pairs can be very large including interactions such as van der Waals forces, hydrogen bonding, hydrophobic/hydrophilic, metal coordination, electrostatics, covalent bonding.

Application of the biological species in the example embodiments is predominantly aqueous wet chemistry with mild conditions, thus avoiding any harsh treatment that may damage sensitive optical components (i.e. high temperature). The fabrication can represent a ‘green’ approach. Many techniques can be used and exist to apply biomolecules to a substrate in well-defined patterns, including ink jet printing and soft lithography. In the example embodiments, complementary biorecognition molecules or thin adhesive coatings drive the assembly of optical components onto virtually any substrate without requiring any micromachining. Biorecognition or thin adhesive coatings can allow previously incompatible materials to be integrated seamlessly on the same device. The biorecognition layer or adhesive coating may allow interesting ‘soft’ and ‘hard’ components to be integrated by themselves or as composites with the optical materials (i.e. responsive polymers and small molecules, metals, nanoparticles and objects, redox and photosynthetic proteins, ionic liquids/liquid crystals, lipid layers, cells, diatoms, silica and polymer beads etc.)

Embodiments of the present invention can provide a hybrid top-down/bottom-up strategy for producing optical structures by biomolecular assembly of high quality optical materials. Labelling the optical material with a biological receptor and the substrate with the complementary ligand (or vice versa) can allow the assembly of any optical structure on any substrate in a well defined manner. This can allow previously unrealized components to be assembled together on the same substrate. No micromachining or masking for lithography is necessary on the substrate and simple liquid transfer techniques can define the pattern (circuit geography). Using a biological assembly approach in the example embodiments can allow flexibility in substrate choice such that any planar substrate can be patterned with a biorecognition molecule for assembling optical structures. Thus, any combination of optical structures may be integrated on any material.

Assembling new materials/devices using biomolecule directed assembly or assembly using adhesive thin films of prefabricated high quality optical components was demonstrated in example embodiments. Biomolecule directed assembly of two optical structures can allow formation of a third optical structure, where the joining of the two optical structures produces a new optical characteristic in the resulting structure. Furthermore, incorporating diverse materials into assemblies with high quality optical components is possible in different embodiments towards a range of new optical materials.

### INDUSTRIAL APPLICATIONS

Integrated optics. There is no current strategy that allows the integration of different optical structures onto the same substrate material. For example, the integration of III-V light sources and detectors with Si based photonic crystals, modulators and/or micro-mirrors, with waveguides and non-linear optical devices on any substrate material in example embodiments constitutes a major advance in optoelectronics.
Optical communications. Biomolecule directed self-assembly in example embodiments can allow improved and easier alignment of optical components and/or nanostructured materials on fibre optic devices.
New optical devices. The integration of many different optical components and materials together using biorecognition in example embodiments can open the door to new functional architectures and optical devices. For example, vertical cavity surface emitting lasers (VCSELs) using porous silicon mirrors and III-V spacer layers, or Er:glass spacer layer. Similarly, VCSEL type architecture with a bio-sensitized spacer layer to make very sensitive biosensors, or alternative materials into the cavity (i.e. responsive polymers and small molecules, metals, nanoparticles and objects, redox and photosynthetic proteins, molecular wires, carbon nanotubes, ionic liquids/liquid crystals, lipid layers, cells, diatoms, silica and polymer beads etc. and composites of the same) could lead to a host of novel devices, such as lasers or optical switches.
Sensors. Forming a biorecognition at the interface that is sensitive to biological species in example embodiments can enable increased biosensing sensitivity at the cavity layer in contrast to previous biosensing work that requires penetration through the mirrors.
Lab-on-a-Chip. Advances in microfluidic technologies have progressed towards realizing the integration of fluid handling, sensing and detection within a single microscale device. Embodiments of the present invention can be applied to lab-on-a-chip technologies (i.e. polycarbonate or other polymeric channels) as a method to integrate optical materials onto a device for e.g. sensing and detection.
Photovoltaics. Existing solar cells can be supplemented with high quality antireflection layers and/or back reflectors in embodiments of the present invention.
Targeted Drug delivery and Medical imaging. Fabricating assembled microparticles from porous silicon with therapeutics confined in the spacer layer with a stimuli responsive material in the embodiments of the present invention. For example, after reaching the target tissue, external (light) or internal (enzymatic, pH, etc.) stimuli causes release of the drug. Engineering the optical properties to be read through tissue (700-1000 nm) may enable monitoring drug delivery or alternatively, a method for medical imaging.
Flat-panel display fabrication, in particular light emitting diode (LEDs) or light emitting crystal (LCD) displays.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, it will be appreciated that other optical characteristics of the free-standing device may be substantially maintained after assembly, other than the transmission/reflectance spectra described for the example embodiments, and including, but not limited to, optically tested characteristics of non-optical devices for substantially maintaining machining tolerances, such as optical interference based characterisation for assembly of micro mechanical or micro electro mechanical systems (MEMS) on a substrate.

1. A method of component assembly on a substrate, the method comprising the steps of:
forming a free-standing component having an optical characteristic;
providing a pattern of a first binding species on the substrate or the free standing component; and
forming a bound component on the substrate through a binding interaction via the first binding species;
wherein the bound component exhibits substantially the same optical characteristic compared to the free-standing component.

2. The method as claimed in claim 1, wherein the forming of the bound component comprises applying the free-standing component to the substrate for establishing the binding interaction via the first binding species, and removing portions of the free-standing component unbound via the first binding species such that the pattern of the first binding species is transferred to the formed bound component.

3. The method as claimed in claim 1, further comprising providing a second binding species on the free-standing component or the substrate, and the binding interaction between the free-standing component and substrate is via the first binding species binding with the second binding species.

4. The method as claimed in claim 1, wherein the substrate comprises a further component formed thereon, and the at least a portion of the free-standing component is bound to a surface of the further component, and wherein the further component and the bound component from at least part of an integrated component.

5. The method as claimed in claim 4, wherein the integrated component comprises an optical component.

6. The method as claimed in claim 4, further comprising forming a material layer on the further component, the free-standing component, or both, such that the material layer is sandwiched between the further component and the bound component in the integrated component.

7. The method as claimed in claim 6, wherein the material layer is chosen such that the integrated component exhibits a desired optical characteristic.

8. The method as claimed in claim 6, wherein the material layer comprises at least the first binding species.

9. The method as claimed in claim 1, wherein the substrate and the free-standing component are lattice mismatched.

10. The method as claimed in claim 1, further comprising the step of providing a blocking species in areas not covered by the pattern of the first binding species, prior to forming the bound component on the substrate through the binding interaction via the first binding species, for enhancing the selectivity of the binding interaction.

11. The method as claimed in claim 1, wherein the first binding species is chosen such that the binding interaction comprises one or more of a group consisting of a biomolecular interaction, van der Waals forces, hydrogen bonding, hydrophobic/hydrophilic, metal coordination, electrostatics, and covalent bonding.

12. The method as claimed in claim 1, comprising:
forming two or more different free-standing components, each free-standing component having an optical characteristic;
providing respective patterns of two or more different first binding species on the substrate; and
providing different second binding species on the respective different free-standing components corresponding to the respective different first binding species,
forming respective bound components on the substrate through binding interactions between the different free-standing components and the different first binding species via the different corresponding second binding species;
wherein the bound components exhibit substantially the same respective optical characteristics compared to the corresponding free-standing components.

13. An assembly comprising:
a substrate; and
a bound component assembled on the substrate through a binding interaction via a first binding species provided on the substrate or on a free-standing pre-form of the bound component;
wherein the bound component exhibits substantially a same optical characteristic compared to the free-standing pre-form.

14. The assembly as claimed in claim 13, wherein the bound component is a portion of the free-standing pre-form with other portions of the free-standing pre-form unbound via the first binding species removed.

15. The assembly as claimed in claim 13, further comprising a second binding species on the bound component or the substrate, and the binding interaction between the bound component and substrate is via the first binding species binding with the second binding species.

16. The assembly as claimed in claim 13, wherein the substrate comprises a further component formed thereon and the bound component is bound to a surface of the further component, and wherein the further component and the bound component from at least part of an integrated component.

17. The assembly as claimed in claim 16, wherein the integrated component comprises an optical component.

18. The assembly as claimed in claim 16, further comprising a material layer on the further component, the bound component, or both, such that the material layer is sandwiched between the further component and the bound component in the integrated component.

19. The assembly as claimed in claim 18, wherein the material layer is chosen such that the integrated component exhibits a desired optical characteristic.

20. The assembly as claimed in claims 18, wherein the material layer comprises at least the first binding species.

21. The assembly as claimed in claim 18, wherein the material layer comprises an organic material, and the further component and the bound component comprise inorganic materials.

22. The assembly as claimed in claim 13, wherein the substrate and the bound component are lattice mismatched.

23. The assembly as claimed in claim 13, wherein the substrate is flexible.

24. The assembly as claimed in claim 13, wherein a lateral dimension of the bound component is in the range of nm to mm.

25. The assembly as claimed in claim 13, comprising:
respective patterns of two or more different first binding species on the substrate; and
different second binding species on respective different bound components corresponding to the respective different first binding species, the bound components being bound through binding interactions between the bound components and the different first binding species via the different corresponding second binding species;
wherein the bound components exhibit substantially the same respective optical characteristics compared to respective corresponding free-standing pre-forms of the different bound components.
